(19) United States
(12) Patent Application Publication
(10) Pub. No.: US 2009/0268142 A1
(43) Pub. Date: Oct. 29, 2009

(54) Liquid crystal display screen

(75) Inventors: Wei-Qi Fu, Beijing (CN); Liang Liu, Beijing (CN); Kai-Li Jiang, Beijing (CN); Shou-Shan Fan, Beijing (CN)

Correspondence Address: PCE INDUSTRY, INC.;ATT. Steven Reiss, 288 SOUTH MAYO AVENUE, CITY OF INDUSTRY, CA, 91789, US

(73) Assignees: Tsinghua University, Beijing City (CN); HON HAI Precision Industry CO., LTD., Tu-Cheng City (TW)

(21) Appl. No.: 12/313,440

(22) Filed: Nov. 20, 2008

(30) Foreign Application Priority Data
Apr. 23, 2008 (CN) 200810066772.X

(51) Int. Cl. G02F 1/1337

(52) U.S. Cl. 349/128; 428/1.2; 977/742

(57) ABSTRACT

A liquid crystal display screen includes a first electrode plate, a second electrode plate opposite to the first electrode plate and a liquid crystal layer sandwiched between the first electrode plate and the second electrode plate. A first alignment layer is located on the first electrode plate and faces the liquid crystal layer. The first alignment layer comprises a plurality of parallel first grooves defined therein. A second alignment layer is located on the second electrode plate and faces the liquid crystal layer. The second alignment layer comprises a plurality of parallel second grooves defined therein. The second grooves are perpendicular to the first grooves. At least one of the first alignment layer and second alignment layer comprises a carbon nanotube layer and a fixing layer located thereon facing the liquid crystal layer. The carbon nanotube layer comprises a plurality of carbon nanotube wires being arranged in parallel and closely located.

### RELATED APPLICATIONS

This application is related to commonly-assigned applications entitled “LIQUID CRYSTAL DISPLAY SCREEN”, filed ______ (Atty. Docket No. US18573); “LIQUID CRYSTAL DISPLAY SCREEN”, filed ______ (Atty. Docket No. US18574); “METHOD FOR MAKING LIQUID CRYSTAL DISPLAY SCREEN”, filed ______ (Atty. Docket No. US18575); “LIQUID CRYSTAL DISPLAY SCREEN”, filed ______ (Atty. Docket No. US19048); “LIQUID CRYSTAL DISPLAY SCREEN”, filed ______ (Atty. Docket No. US19049); and “METHOD FOR MAKING LIQUID CRYSTAL DISPLAY SCREEN”, filed ______ (Atty. Docket No. US19051). The disclosures of the above-identified applications are incorporated herein by reference.

### BACKGROUND

1. Field of the Invention

The present invention relates to liquid crystal display screens.

2. Discussion of Related Art

Referring to FIG. 7, a conventional liquid crystal display screen 100 for a liquid crystal display (LCD) generally includes a first electrode plate 104, a second electrode plate 112, and a liquid crystal layer 118. The first electrode plate 104 is located in parallel to the second electrode plate 112. The liquid crystal layer 118 is located between the first electrode plate 104 and the second electrode plate 112. A first transparent electrode layer 106 and a first alignment layer 108 are formed in that order on an inner surface of the first electrode plate 104 that faces toward the liquid crystal layer 118. A first polarizer 102 is formed on an outer surface of the first electrode plate 104 that faces away from the liquid crystal layer 118. A second transparent electrode layer 114 and a second alignment layer 116 are formed in that order on an inner surface of the second electrode plate 112 that faces toward the liquid crystal layer 118. A second polarizer 110 is formed on an outer surface of the second electrode plate 112 that faces away from the liquid crystal layer 118.

The quality and performance of the alignment layers 108, 116 are key factors that determine the display quality of the liquid crystal display screen 100. A high quality liquid crystal display screen demands steady and uniform arrangement of liquid crystal molecules 1182 of the liquid crystal layer 118. This is achieved in part by a correct arrangement of the liquid crystal molecules 1182 at the alignment layers 108, 116. Materials to make the alignment layers 108, 116 are typically selected from the group comprising of polystyrene, polystyrene derivative, polyimide, polyvinyl alcohol, epoxy resin, polyamine resin, and polysiloxane. The selected material is manufactured into a preform of each alignment layer 108, 116. The preform is then treated by one method selected from the group comprising of rubbing, incline silicon oxide evaporation, and atomic beam alignment micro-treatment. Thereby, grooves are formed on the treated surface of the preform, and the alignment layer 108, 116 is obtained. The grooves affect the arrangement and orientations of the liquid crystal molecules 1182 thereat.

In the liquid crystal display screen 100, the liquid crystal molecules 1182 are rod-like. A plurality of parallel first grooves 1082 are formed at an inner surface of the first alignment layer 108. A plurality of parallel second grooves 1162 are formed at an inner surface of the second alignment layer 116. A direction of alignment of each of the first grooves 1082 is perpendicular to a direction of alignment of each of the second grooves 1162. The grooves 1082, 1162 function so as to align the orientation of the liquid crystal molecules 1182 thereat. Particularly, the liquid crystal molecules 1182 adjacent to the alignment layers 108, 116 are aligned parallel to the grooves 1082, 1162 respectively. When the grooves 1082 and 1162 are at right angles and the substrates 104 and 112 are spaced appropriately from each other, the liquid crystal molecules 1182 can automatically twist progressively over a range of 90 degrees from the top of the liquid crystal layer 118 to the bottom of the liquid crystal layer 118.

The polarizers 102 and 110 and the transparent electrode layers 106 and 114 play important roles in the liquid crystal display screen 100. However, the polarizers 102 and 110 and the transparent electrode layers 106 and 114 may make the liquid crystal display screen 100 unduly thick, which may reduce the transparency of the liquid crystal display screen 100. Moreover, the polarizers 102 and 110 and the transparent electrode layers 106 and 114 typically increase the cost of manufacturing the liquid crystal display screen 100.

What is needed, therefore, is to provide a liquid crystal display screen with a simple structure, reduced thickness, and excellent arrangement of liquid crystal molecules.

### BRIEF DESCRIPTION OF THE DRAWINGS

Many aspects of the present liquid crystal display screen can be better understood with references to the following drawings. The components in the drawings are not necessarily drawn to scale, the emphasis instead being placed upon clearly illustrating the principles of the present liquid crystal display screen.

FIG. 1 is a schematic, isometric view of a liquid crystal display screen in accordance with one embodiment of the present invention.

FIG. 2 is a cutaway view of the liquid crystal display screen cutting down along the line II-II shown in FIG. 1.

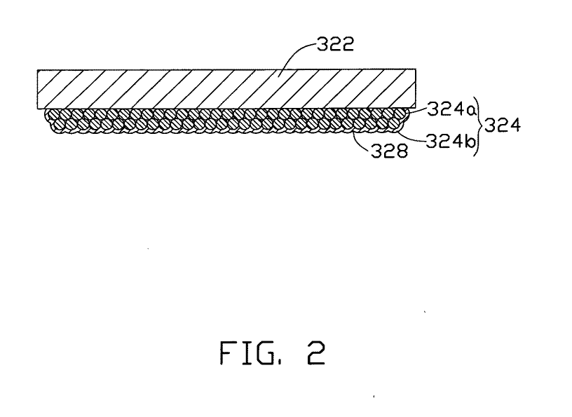

FIG. 3 is a cutaway view of the liquid crystal display screen cutting down along the line III-III shown in FIG. 1.

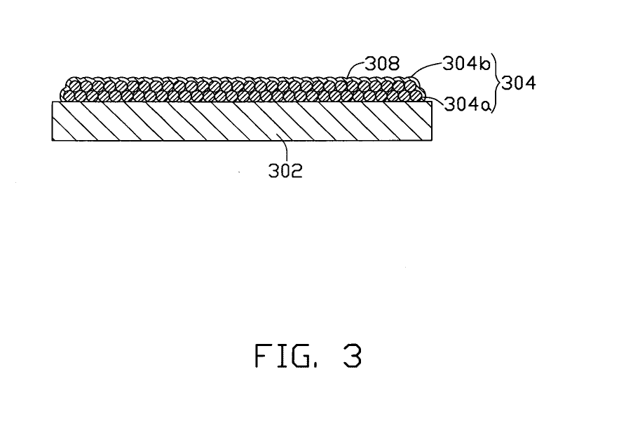

FIG. 4 shows a Scanning Electron Microscope (SEM) image of a carbon nanotube wire used as an alignment layer in the liquid crystal display screen of the present embodiment.

FIG. 5 is similar to FIG. 1, showing the liquid crystal display screen in a light transmitting state.

FIG. 6 is similar to FIG. 1, but showing the liquid crystal display screen in a light blocking state.

FIG. 7 is a schematic, isometric view of a conventional liquid crystal display screen according to the prior art.

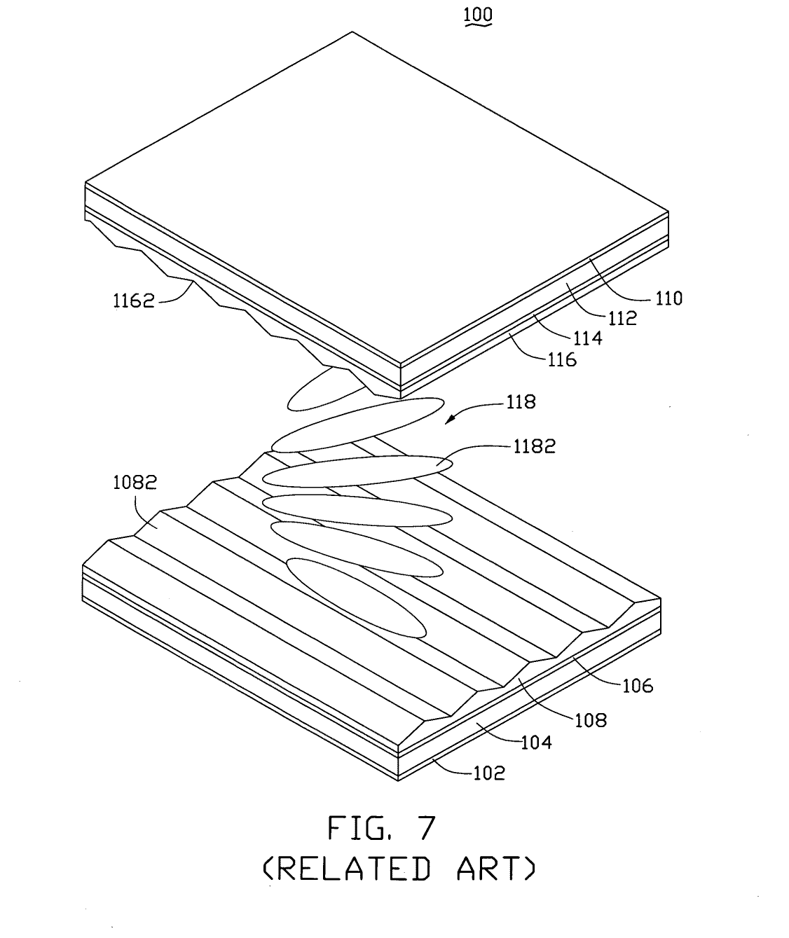

Corresponding reference characters indicate corresponding parts throughout the several views. The exemplifications set out herein illustrate at least one preferred embodiment of the present liquid crystal display screen, in at least one form, and such exemplifications are not to be construed as limiting the scope of the invention in any manner.

### DETAILED DESCRIPTION OF EXEMPLARY EMBODIMENTS

References will now be made to the drawings to describe, in detail, various embodiments of the present liquid crystal display screen.

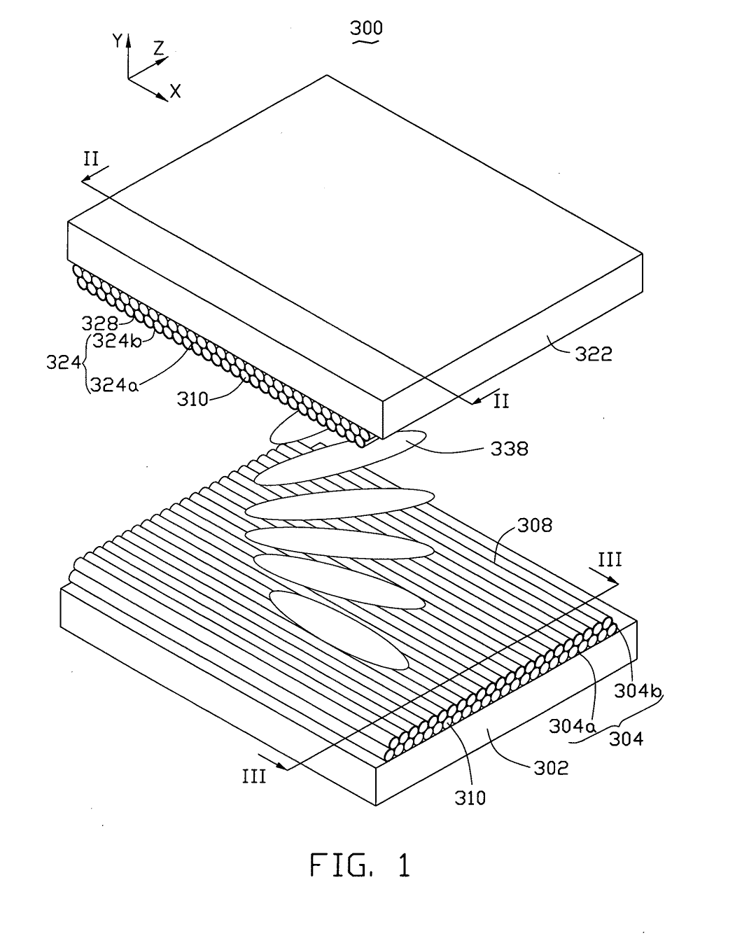

Referring to FIG. 1, a liquid crystal display screen 300 includes a first electrode plate 302, a first alignment layer 304, a liquid crystal layer 338, a second alignment layer 324, and a second electrode plate 322. The first electrode plate 302 is opposite to the second electrode plate 322. The liquid crystal layer 338 is sandwiched between the first electrode plate 302 and the second electrode plate 322. The first alignment layer 304 is located on the first electrode plate 302, adjacent to the liquid crystal layer 338. The first alignment layer 304 includes a plurality of parallel first grooves 308 formed thereat and facing the liquid crystal layer 338. The second alignment layer 324 is located on the second electrode plate 322 adjacent to the liquid crystal layer 338. The second alignment layer 324 includes a plurality of parallel second grooves 328 formed thereat and facing the liquid crystal layer 338. The first grooves 308 are aligned perpendicularly to the second grooves 328.

The material of the first electrode plate 302 and the second electrode plate 322 is selected from the group comprising of glass, quartz, diamond, and plastics. In the present embodiment, the first electrode plate 302 and the second electrode plate 322 are made of flexible materials, such as cellulose triacetate (CTA).

The liquid crystal layer 338 includes a plurality of rod-like liquid crystal molecules. The liquid crystal layer 338 can also be made of other liquid crystal materials, which are generally used in the present technology.

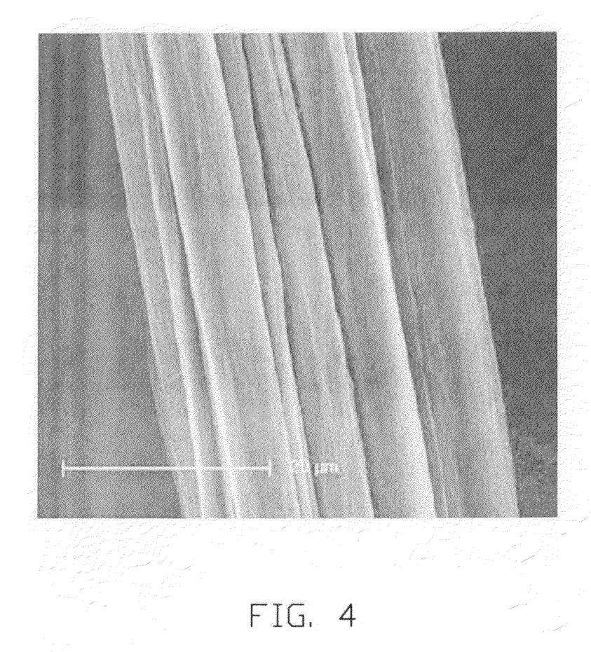

The first alignment layer 304 includes a first carbon nanotube layer 304a and a first fixing layer 304b. The first fixing layer 304b is located on the first carbon nanotube layer 304a facing the liquid crystal layer 338. The first carbon nanotube layer 304a includes a plurality of carbon nanotube wires 310 arranged in parallel and closely stacked. Referring to FIG. 4, the carbon nanotube wire 310 is composed of a plurality of successive carbon nanotubes joined end to end by van der Waals attractive force therebetween and are one or more carbon nanotubes in thickness. Also the carbon nanotube wire 310 is composed of a plurality of successive twist carbon nanotubes joined end to end by van der Waals attractive force therebetween. The carbon nanotube wires 310 is parallel to each other and closely located side by side. The length of the carbon nanotube wire 310 can be arbitrarily set as desired. A diameter of each carbon nanotube wire 310 is in an approximate range from 0.5 nanometers to 10 micrometers (μm). Distances between adjacent carbon nanotube wires 310 are in an approximate range from 10 nanometers to 10 micrometers. The carbon nanotubes in the carbon nanotube wires 310 can be selected from a group comprising of single-walled, double-walled, and multi-walled carbon nanotubes. A diameter of each single-walled carbon nanotube approximately ranges from 0.5 nanometers to 50 nanometers. A diameter of each double-walled carbon nanotube approximately ranges from 1 nanometer to 50 nanometers. A diameter of each multi-walled carbon nanotube approximately ranges from 1.5 nanometers to 50 nanometers.

The second alignment layer 324 can be a conventional alignment layer such as a polyamide layer or a carbon nanotube layer similar to the first alignment layer 304. In the present embodiment, the second alignment layer 324 is a carbon nanotube layer and a given fixing layer. In the present embodiment, the first alignment layer 304 includes a first carbon nanotube layer 304a and a first fixing layer 304b; and the second alignment layer 324 includes a second carbon nanotube layer 324a and a second fixing layer 324b. Due to the carbon nanotube layers 304a and 324a having a plurality of parallel and uniform gaps, when the first fixing layer 304b and the second fixing layer 324b are correspondingly formed on the first carbon nanotube layer 304a and the second carbon nanotube layer 324a, the first grooves 308 and the second grooves 328 are respectively formed on surfaces of the first fixing layer 304b and the second fixing layer 324b. The first grooves 308 and the second grooves 328 affect the alignment of the liquid crystal molecules thereat.

In order to keep extending direction of the first grooves 308 perpendicular to the extending direction of the second grooves 328, the extending direction of the carbon nanotube wires 310 in the first carbon nanotube layer 304a is perpendicular to the carbon nanotube wires 310 in the second carbon nanotube layer 324a. Specifically, the carbon nanotube wires 310 in the first carbon nanotube layer 304a are each aligned in parallel to the X-axis, while the carbon nanotube wires 310 in the second alignment layer 324 are each aligned in parallel to the Z-axis. A thickness of each of the first alignment layer 304 and the second alignment layer 324 ranges from 20 nanometers to 5 micrometers.

The materials of the fixing layers 304b and 324b are selected from the group consisted of diamond, silicon nitrogen, hydride of random silicon, silicon carbon, silicon dioxide, aluminium oxide, tin oxide, cerium oxide, zinc titanate, and indium titanate. The fixing layers 304b and 324b can be fabricated by means of evaporating, sputtering, or plasma enhanced chemical vapor deposition. Also, the materials of the fixing layers 304b and 324b are selected from the group comprising of polyethylene ethanol, polyamide, polymethyl methacrylate, and polycarbonate. Accordingly, the fixing layers 304b and 324b are sprayed on the first carbon nanotube layer 304a and the second carbon nanotube layer 324a. A thickness of the fixing layers approximately ranges from 20 nanometers to 2 micrometers.

Due to the carbon nanotube layers having good tensile properties, when the first electrode plate 302 and the second electrode plate 322 are made of the flexible materials, the liquid crystal display screen 300 is correspondingly flexible. Moreover, the carbon nanotubes provide each carbon nanotube layer with good electrical conductivity. As a result, each carbon nanotube layer can be used to conduct electricity and thereby replace a conventional transparent electrode layer. Specifically, the carbon nanotube layer can act as both an alignment layer and an electrode layer. This simplifies the structure and reduces the thickness of the liquid crystal display screen 300, thereby enhancing the efficiency of usage of an associated backlight. Additionally, it forms a plurality of parallel gaps between the carbon nanotube wires 310 in the first carbon nanotube layer 304a and the second carbon nanotube layer 324a without other mechanical treatments (such as rubbing the carbon nanotube film). Thus, the conventional art problem of electrostatic charge and dust contamination can be avoided, while the corresponding alignment layers 304, 324 have improved alignment quality.

Furthermore, by covering a fixing layer 304b, 324b on the carbon nanotube layer 304a, 324a, this prevents the carbon nanotube layer 304a, 324a of the alignment layer 304, 324 from falling off when the carbon nanotube layer 304a, 324a are in contact with the liquid crystal layer 338. Therefore, the liquid crystal display screen 300 has improved durability and an excellent arrangement of liquid crystal molecules. The first carbon nanotube layer 304a and the second carbon nanotube layer 324a will fall off easily without the first fixing layer 304b and the second fixing layer 324b. If the carbon nanotube fell off from the first carbon nanotube layer 304a, the second carbon nanotube layer 324a will result in a short circuit, thereby damaging the liquid crystal display screen 300.

Because the carbon nanotube wires 310 in each carbon nanotube layer are arranged in parallel, the carbon nanotube layer has a light polarization characteristic, and as a result, can be used to replace a conventional polarizer. Nevertheless, in order to obtain a better polarization effect, at least one polarizer is located on a surface of the first electrode plate 302 that faces away from the liquid crystal layer 338, and/or on a surface of the second electrode plate 322 that faces away from the liquid crystal layer 338.

Furthermore, the liquid crystal display screen 300 includes at least two electrodes electrically connected to the first carbon nanotube layer 304a and the second carbon nanotube layer 324a, respectively. The electrodes are used to apply a voltage to the alignment layers 304 and 324.

The liquid crystal display screen 300 provided in the present embodiment is a single-pixel liquid crystal display screen. By arranging a number of the liquid crystal display screens 300 in a predetermined fashion, a multi-pixel liquid crystal display screen could be obtained. The multi-pixel liquid crystal display screen could have the same or different substrate.

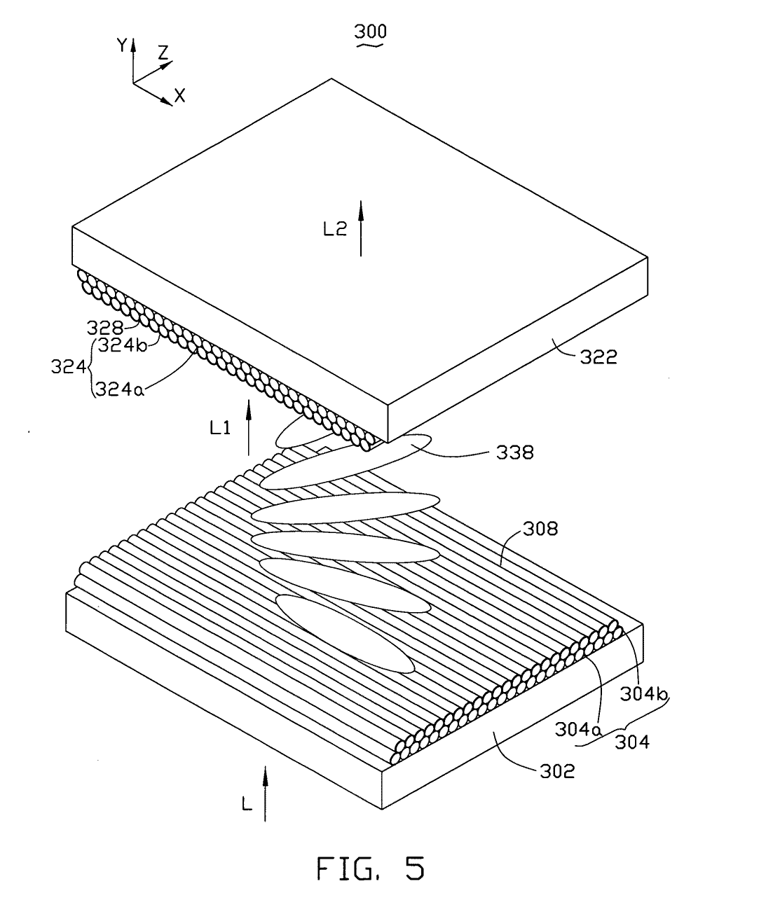

Referring to FIG. 5, when no voltage is applied to the alignment layers 304 and 324, the arrangement of the liquid crystal molecules is in accordance with alignment directions of the alignment layers 304, 324. In this embodiment, the alignment directions of the alignment layers 304, 324 are at right angles, and as a result, the liquid crystal molecules can be automatically oriented so that they turn a total of 90 degrees from a top of the liquid crystal layer 338 to a bottom of the liquid crystal layer 338. When light L is shone upon the first alignment layer 304, because a transmission axis 309 of the first alignment layer 304 is located along the z-axis, only polarization light L1 with a polarization direction parallel to the transmission axis 309 can pass through the first alignment layer 304. When the polarization light L1 passes through the liquid crystal molecules, and because the liquid crystal molecules turn 90 degrees from bottom to top, the polarization direction of the polarization light L1 is also turned 90 degrees and becomes polarization light L2 which is parallel to the x-axis. The polarization light L2 passing through the liquid crystal molecules can pass through the second alignment layer 324 because a transmission axis 329 of the second alignment layer 324 is along the x-axis. As a result, the liquid crystal display screen 300 transmits light.

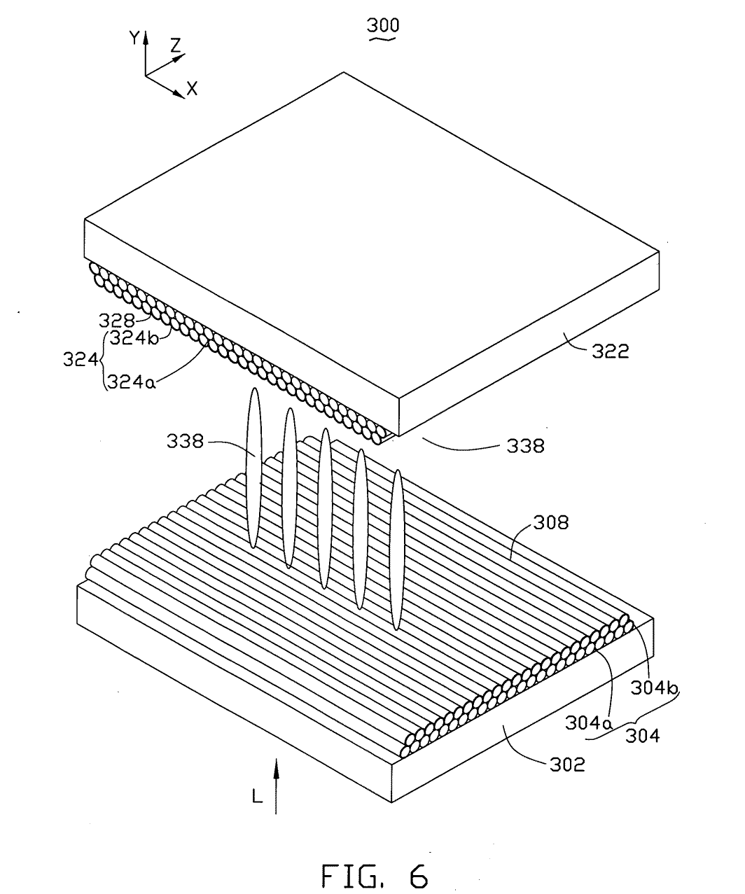

Referring to FIG. 6, when a voltage is applied to the alignment layers 304 and 324, an electrical field perpendicular to the alignment layers 304 and 324 is formed. Under the influence of the electrical field, the liquid crystal molecules are oriented to become parallel to the direction of the electrical field. Accordingly, the polarization light L1 passing through the liquid crystal molecules keeps its polarization direction along the Z-axis and, therefore, cannot pass through the second alignment layer 324. As a result, the liquid crystal display screen 300 blocks light.

Finally, it is to be understood that he above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A liquid crystal display screen comprising:
a first electrode plate;
a second electrode plate opposite to the first electrode plate;
a liquid crystal layer sandwiched between the first electrode plate and the second electrode plate;
a first alignment layer located on the first electrode plate and facing the liquid crystal layer, the first alignment layer comprising a plurality of parallel first grooves defined therein;
a second alignment layer located on the second electrode plate and facing the liquid crystal layer, the second alignment layer comprising a plurality of parallel second grooves defined therein, an alignment direction of the second grooves being perpendicular to an alignment direction of the first grooves; and
at least one of the first alignment layer and second alignment layer comprising a carbon nanotube layer and a fixing layer located thereon facing the liquid crystal layer, the carbon nanotube layer comprising a plurality of carbon nanotube wires being arranged in parallel and closely located.

2. The liquid crystal display screen as claimed in claim 1, wherein a diameter of the carbon nanotube wires approximately ranges from 0.5 nanometers to 10 micrometers.

3. The liquid crystal display screen as claimed in claim 1, wherein each carbon nanotube wire comprises a plurality of successive carbon nanotubes joined end to end by van der Waals attractive force therebetween.

4. The liquid crystal display screen as claimed in claim 1, wherein each carbon nanotube wire comprises a plurality of successive twist carbon nanotubes joined end to end by van der Waals attractive force therebetween.

5. The liquid crystal display screen as claimed in claim 1, wherein each carbon nanotube wire are one or more carbon nanotubes in thickness.

6. The liquid crystal display screen as claimed in claim 3, wherein the carbon nanotubes in the carbon nanotube wire are selected from a group comprising of single-walled carbon nanotubes, double-walled carbon nanotubes, and multi-walled carbon nanotubes.

7. The liquid crystal display screen as claimed in claim 3, wherein diameters of the single-walled carbon nanotubes approximately range from 0.5 nanometers to 50 nanometers, diameters of the double-walled carbon nanotubes approximately range from 1 nanometer to 50 nanometers, and diameters of the multi-walled carbon nanotubes approximately range from 1.5 nanometers to 50 nanometers.

8. The liquid crystal display screen as claimed in claim 1, wherein a plurality of uniformly distributed and parallel gaps are defined between the adjacent carbon nanotube wires.

9. The liquid crystal display screen as claimed in claim 8, wherein the fixing layer comprises a plurality of grooves being opposite to the gaps in the carbon nanotube layer, and the grooves constitute the first grooves of the first alignment layer or the second groove of the second alignment layer.

10. The liquid crystal display screen as claimed in claim 1, wherein the material of the fixing layer is selected from the group comprising of diamond, silicon nitrogen, hydride of random silicon, silicon carbon, silicon dioxide, aluminium oxide, tin oxide, cerium oxide, zinc titanate, and indium titanate.

11. The liquid crystal display screen as claimed in claim 1, wherein the material of the fixing layer is selected from the group comprising of polyethylene ethanol, polyamide, polymethyl methacrylate, and polycarbonate.

12. The liquid crystal display screen as claimed in claim 1, wherein a thickness of the fixing layer ranges from 20 nanometers to 2 micrometers.

13. The liquid crystal display screen as claimed in claim 1, wherein both the first and second alignment layers comprising a carbon nanotube layer and a fixing layer, the carbon nanotube layer comprises a plurality of carbon nanotube wires being arranged in parallel and closely located, the extending direction of the carbon nanotube wires in the first alignment layer is perpendicular to the carbon nanotube wires in the second alignment layer.

14. The liquid crystal display screen as claimed in claim 13, wherein a plurality of uniformly distributed and parallel gaps are defined between the adjacent carbon nanotube wires, the fixing layer comprising a plurality of grooves being opposite to the gaps in the carbon nanotube layer, and the grooves constituting the first grooves of the first alignment layer and the second groove of the second alignment layer.

15. The liquid crystal display screen as claimed in claim 1, wherein a thickness of the first alignment layer and the second alignment layer approximately ranges from 1 micrometer to 50 micrometers.

16. The liquid crystal display screen as claimed in claim 1, wherein the first electrode plate and the second electrode plate are made of flexible transparent materials, the flexible transparent material is cellulose triacetate.

17. The liquid crystal display screen as claimed in claim 1, wherein the first electrode plate and the second electrode plate are made of hard transparent materials, the hard transparent materials are selected from the group comprising of glass, silicon, diamond, and plastics.

18. The liquid crystal display screen as claimed in claim 1, further comprising at least one polarizer, wherein the polarizer is located on at least one of the first or the second electrode plates.

19. The liquid crystal display screen as claimed in claim 1, further comprising at least one polarizer, the polarizer being located on the first electrode plate and the second electrode plate.

20. The liquid crystal display screen as claimed in claim 1, further comprising at least two electrodes electrically connected to the first carbon nanotube layer and the second carbon nanotube layer respectively.
